(19) United States
(12) Patent Application Publication
(10) Pub. No.: US 2014/0269739 A1
(43) Pub. Date: Sep. 18, 2014

(54) HIGH AVAILABILITY SERVER CONFIGURATION WITH N + M ACTIVE AND STANDBY SYSTEMS

(71) Applicants: Lynnette K. Evans, Malvern, PA (US); Bradford Sherman, Malvern, PA (US); Richard Furbee, Malvern, PA (US); Joseph P. Neill, Malvern, PA (US); Alan Ponting, Malvern, PA (US)

(72) Inventors: Lynnette K. Evans, Malvern, PA (US); Bradford Sherman, Malvern, PA (US); Richard Furbee, Malvern, PA (US); Joseph P. Neill, Malvern, PA (US); Alan Ponting, Malvern, PA (US)

(73) Assignee: Unisys Corporation, Blue Bell, PA (US)

(21) Appl. No.: 14/191,815

(22) Filed: Feb. 27, 2014

Related U.S. Application Data
(60) Provisional application No. 61/787,131, filed on Mar. 15, 2013.
(60) Provisional application No. 61/787,151, filed on Mar. 15, 2013.

(51) Int. Cl. H04L 12/931

(52) U.S. Cl. CPC H04L 49/356
USPC 370/400

(57) ABSTRACT

A switch may be configured with multiple zones to provide access to an external storage to certain processing systems. For example, the switch may be configured with two zones, in which a first zone configuration provides access to the external storage for a first processing system and a second zone configuration provides access to the external storage for a second processing system. Thus, the switch may provide high availability of the external storage and allow seamless transition from one computer system to another computer system.

### CROSS-REFERENCE TO RELATED APPLICATIONS

This applications claims the benefit of priority of U.S. Provisional Patent Application No. 61/787,131 filed on Mar. 15, 2013 and U.S. Provisional Patent Application No. 61,787,151 filed on Mar. 15, 2103, both of which are incorporated by reference in their entirety.

### FIELD OF THE DISCLOSURE

The instant disclosure relates to computer systems. More specifically, this disclosure relates to switchover between active and standby processing systems.

### BACKGROUND

Computer systems, and servers in particular, form an information backbone upon which companies now rely on almost exclusively for data storage, data mining, and data processing. These systems are indispensable for the improved efficiency and accuracy at processing data as compared to manual human processing. Furthermore, these systems provide services that could not be realistically accomplished by human processing. For example, some computer systems execute physical simulations in hours that would otherwise take decades to complete by human computations. As another example, some computer systems store terabytes of data and provide instantaneous access to any of the data, which may include records spanning decades of company operations. The ability to quickly recover from failures within the computer systems is critical to maintaining these computer systems.

### SUMMARY

According to one embodiment, an apparatus or system may include a first processing system comprising a first local storage; a second processing system comprising a second local storage; an external storage; and a switch coupled to the first processing system, to the second processing system, and to the external storage. The switch may be configured to, when the switch is in a first zone configuration, provide access to the external storage to the first processing system. The switch may also be configured to, when the switch is in a second zone configuration, provide access to the external storage to the second processing system.

According to another embodiment, a method may include receiving, at a switch, a command to switch a zone configuration from a first zone configuration to a second zone configuration, wherein the first zone configuration provides access to an external storage to a first processing system, and wherein the second zone configuration provides access to the external storage to a second processing system; disabling, by the switch, access to the external storage by the first processing system; and enabling, by the switch, access to the external storage by the second processing system.

According to a further embodiment, a method may include determining, at a standby processing system, to switch from an active processing system to the standby processing system; communicating, by the standby processing system to a switch, an instruction to switch from a first zone configuration to a second zone configuration; and acquiring, by the standby processing system, external storage coupled to the switch after the switch switches to the second zone configuration.

According to one embodiment, an apparatus or system may include a first processing system comprising a first local storage; a second processing system comprising a second local storage; a third processing system comprising a third local storage; an external storage; and a switch coupled to the first processing system, to the second processing system, to the third processing system, and to the external storage. The switch may be configured to, when the switch is in a first zone configuration, provide access to the external storage to the first processing system. The switch may also be configured to, when the switch is in a second zone configuration, provide access to the external storage to the second processing system. The switch may further be configured to, when the switch is in a third zone configuration, provide access to the external storage to the third processing system.

According to another embodiment, a method may include receiving, at a switch, a command to switch a zone configuration from a first zone configuration to at least one of a second zone configuration and a third zone configuration, wherein the first zone configuration provides access to an external storage to a first processing system, wherein the second zone configuration provides access to the external storage to a second processing system, and wherein the third zone configuration provides access to the external storage to a third processing system; disabling, by the switch, access to the external storage by the first processing system; and enabling, by the switch, access to the external storage by the second processing system.

According to a further embodiment, a method may include determining, at a standby processing system, to switch from an active processing system to the standby processing system; configuring the standby processing system to replace the active processing system; communicating, by the standby processing system to a switch, an instruction to switch from a first zone configuration to a second zone configuration; and acquiring, by the standby processing system, external storage coupled to the switch after the switch switches to the second zone configuration.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a switch in a first zone configuration according to one embodiment of the disclosure.

FIG. 2 is a block diagram illustrating a switch in a second zone configuration according to one embodiment of the disclosure.

FIG. 3 is a flow chart illustrating a method of switching from an active processing system to a standby processing system by changing zone configurations on a switch according to one embodiment of the disclosure.

FIG. 4 is a flow chart illustrating a method of reconfiguring a switch for a different zone configuration according to one embodiment of the disclosure.

FIG. 5 is a flow chart illustrating a method of switching a standby processing system to an active processing system by reconfiguring software on the standby processing system according to one embodiment of the disclosure.

FIG. 6 is a flow chart illustrating a method of switching an active processing system to a standby processing system by reconfiguring software on the active processing system according to one embodiment of the disclosure.

FIG. 7 is a block diagram illustrating a system with redundant switches for accessing an external storage according to one embodiment of the disclosure.

FIG. 8 is a block diagram illustrating a system with redundant switches and multiple active systems for accessing external storage according to one embodiment of the disclosure.

FIG. 9 is a block diagram illustrating a computer system according to one embodiment of the disclosure.

### DETAILED DESCRIPTION

A switch may be configured with multiple zones to provide access to an external storage to certain processing systems. For example, the switch may be configured with two zones, in which a first zone configuration provides access to the external storage for a first processing system and a second zone configuration provides access to the external storage for a second processing system. FIG. 1 is a block diagram illustrating a switch in a first zone configuration according to one embodiment of the disclosure. A first processing system 102 and a second processing system 112 of a system 100 may both be coupled to a switch 122. The switch 122 may have a plurality of communications ports, and the communications ports may be assigned to zones.

The first processing system 102 may have access to local storage 104 and local sitedata 106. The second processing system 112 may have access to local storage 114 and local sitedata 116. Data stored on the local storage and sitedata may include machine-dependent data, such as networking data or host-specific data used during a switch-over process. In one embodiment, local data may not move between hosts. In one embodiment, the local data and sitedata may include a minimal environment for a standby host to be running and communicating with the active hosts in addition to machine-configuration information.

An external storage 124 may be coupled to the switch 122 and made available to the first and second processing systems 102 and 112 through the switch 122. Data storage on external storage 124 may include data used to run a system in production mode and data that is not site-specific. For example, the data may include databases, application data, and voice data along with the active, production system's operating environment. Other external storage systems 126 may also be coupled to the switch 122 and configured to provide data to one or both of the processing systems 102 and 112. Other external storage systems 126 may include CD storage, tape drives, etc.

When the switch 122 is configured with the first zone configuration, the switch 122 may provide access 132 to the external storage 124 to only the first processing system 102. In this configuration, the first processing system 102 may be the active system and the second processing system 112 may be the standby system. For example, when data from a database is requested by a client device, the first processing system 102 may respond to the client device, while the second processing system 112 remains idle. While the first zone configuration is active on the switch 122, the local storage 104 may be not visible and/or the local sitedata 106 may be visible. The sitedata 106 may include data that is specific to a host, such as networking information (e.g., MAC addresses). Other data, such as Internet Protocol (IP) addresses may be stored on the external storage 124. For voice systems, the sitedata 106 may include information related to whether a switch-over is in progress to prevent external Network Interface Units from being reinitialized. While the first processing system 102 is the active system, the system 102 may have a first hostname, such as “VSE420A,” where “A” denotes “active.” A second hostname, such as “VSE402S,” where “S” denotes standby, may be assigned to the second processing system 112. While the second processing system 112 is the standby system, the system 112 may be restricted from accessing the external storage 124 and have access 134 to local storage 114. The second processing system 112 may also have access to other storage systems (not shown) separate from the external storage 124.

When the first processing system 102 becomes unavailable, such as due to a hardware or software failure or maintenance, the second processing system 112 may become the active system by configuring the switch 122 with the second zone configuration. FIG. 2 is a block diagram illustrating a switch in a second zone configuration according to one embodiment of the disclosure. When the switch 122 is configured with the second zone configuration, the switch 122 may provide access 234 to the external storage 124 to only the second processing system 112. In this configuration, the second processing system 112 may be the active system and the first processing system 102 may be the standby system. For example, when data from a database is requested by a client device, the second processing system 112 may respond to the client device, while the first processing system 102 remains idle. While the second zone configuration is active on the switch 122, the local storage 114 may be not visible and/or the local sitedata 116 may be visible. While the second processing system 112 is the active system, the system 112 may use the first hostname. By reassigning the hostname to the second processing system 112, client devices may continue to operate without knowing the zone configuration of the switch 122. That is, the client device will not know which of the processing systems 102 and 112 is active but will continue to receive uninterrupted service regardless of which of the systems 102 and 112 is active. When the first hostname is reassigned to the processing system 112 the second hostname may be reassigned to the processing system 102.

FIG. 3 is a flow chart illustrating a method of switching from an active processing system to a standby processing system by changing zone configurations on a switch according to one embodiment of the disclosure. A method 300 begins at block 302 with a determination to switch from the active system to the standby system. Criteria to make a determination to switch-over may include whether the active system is non-responsive and/or whether a user request is received when a user notices an issue with the system such as underperformance. The decision may be made based on rules established on the active system, the standby system, the switch, and/or a management system communicating with the system 100. The decision may also be made when user input is received from an administrator instructing the system 100 to switch the active and standby systems. At block 304, the standby system instructs the switch to enter the second zone configuration, corresponding to the standby system becoming the new active system. In some embodiments, the instruction provided to the switch may be transmitted by other devices coupled to the switch or the instruction may be generated by the switch. At block 306, the standby system becomes the new active system and the active system becomes the new standby system.

When the active and standby systems switch roles, the switch 122 coupled to the external storage 124 may reconfigure based on the zone configuration corresponding to the new active system. FIG. 4 is a flow chart illustrating a method of reconfiguring a switch for a different zone configuration according to one embodiment of the disclosure. A method 400 begins at block 402 with receiving a command to switch to the second zone configuration, which corresponds to the new active system. At block 404, the switch 122 disables access to the external storage 124 by the first processing system 102 (the new standby system). At block 406, the switch 122 enables access to the external storage 124 by the second processing system 112 (the new active system).

When the first or the second processing system 102 or 112 switch from acting as the standby system to acting as the active system, the systems 102 and 112 may reconfigure to carry out the functions associated with being assigned as the acting system. An example of the reconfiguration of the second processing system 112 is shown in FIG. 5. FIG. 5 is a flow chart illustrating a method of switching a standby processing system to an active processing system by reconfiguring software on the standby processing system according to one embodiment of the disclosure. A method 500 begins at block 502 with acquiring, by the second processing system, the external storage 124. For example, the second processing system 112 may mount the external storage 124 after the switch 122 switches to the second zone configuration to provide access to the external storage 124 to the second processing system 112. At block 504, the second processing system may change a halt-load unit of the second processing system to the halt-load unit in the external storage 124. The halt-load unit may be, for example, a disk drive that holds the operating system and where the firmware knows to look to reinitialize the system. At block 506, the second processing system may halt load off the external storage 124. A halt and load of the processing system may be, for example, rebooting the processing system. At block 508, the second processing system may respond to requests from client devices based, at least in part, on data stored on the external storage 124.

When the first or the second processing system 102 or 112 switch from acting as the active system to acting as the standby system, the systems 102 and 112 may reconfigure to stop performing the functions associated with being assigned as the acting system. An example of the reconfiguration of the first processing system 102 is shown in FIG. 6. FIG. 6 is a flow chart illustrating a method of switching an active processing system to a standby processing system by reconfiguring software on the active processing system according to one embodiment of the disclosure. A method 600 begins at block 602 with the first processing system 102 halting. At block 604, the halt-load of the first processing system 102 is changed to the local storage 104. At block 606, the first processing system 102 halt loads off the first local storage 104. The steps of FIG. 6 may be performed after the second processing system 112 is assigned as the active system. After the method 600 is performed, the first processing system 102 may be placed in a standby state and available to resume operation as the active system when another determination is made to switch the standby and the active systems.

The system 100 may be configured with redundant switches, which may further improve availability of the system 100. FIG. 7 is a block diagram illustrating a system with redundant switches for accessing an external storage according to one embodiment of the disclosure. A system 700 may include switches 722 and 724 configured with redundant communications. For example, the switch 722 and the switch 724 may both be coupled to the first processing system 102 and to the second processing system 112. Likewise, the switch 722 and the switch 724 may both be coupled to the external storage 124. In a configuration similar to that of FIG. 7, if one of the switches 722 or 724 fails, the system 700 may continue to operate. In one embodiment, the switches 722 and 724 may be controlled synchronously such that a change in zone configuration to one of the switches 722 or 724 also applies to the other of the switches 722 or 724.

In one embodiment, the processing systems 102 and 112 may be configured to include processor-memory modules (PMMs) 706 and 716, respectively, and integrated service management (ISM) 708 and 718, respectively. The processor-memory modules (PMMs) 706 and 716 may include one or more processors, such as x86, ARM, x64 processors, and memory, such as random access memory (RAM). These PMMs 706 may perform calculations in response to requests from client devices. The integrated service management modules (ISM) may perform certain input/output (I/O) requests for the processing system. The PMMs 706 and 716 and ISMs 708 and 718 may be coupled through a communications network such as, for example, InfiniBand (IB).

The system 700 may be configured with multiple active systems. When multiple active systems are present, the active systems may be configured similarly to perform similar tasks, such that more client devices may be serviced by the system 700, or the active systems may be configured to perform different functions, such that client devices may be provided with multiple functionalities. Regardless of the configuration of the active systems, a standby system may be capable of switching roles with any of the active systems. Thus, fewer standby systems may be used in a system to reduce the cost of deployment of the system. FIG. 8 is a block diagram illustrating a system with redundant switches and multiple active systems for accessing external storage according to one embodiment of the disclosure. A system 800 may include a first active system 802, a second active system 812, and a standby system 822.

Each of the systems 802, 812, and 822 may include a PMM 804, 814, and 824, respectively, and a ISM 806, 816, and 826, respectively. Switches 832, 834, 836, and 838 may be configured in a redundant setup to provide communication between the systems 802, 812, and 822, and external storage 842 and 844. In one embodiment, the external storage 844 may be configured to mirror the external storage 842, such that failure of one of the external storage 842 or 844 does not result in a failure of the system 800. When the switches 832, 834, 836, and 838 are configured in a redundant setup, each of the switches 832, 834, 836, and 838 may be coupled to each of the systems 802, 812, and 822 and to each of the external storage 842 and 844.

The systems 802, 812, and 822 may also be coupled to secure access devices 808, 818, and 828, respectively. The secure access devices 808, 818, and 828 may provide access to the systems 802, 812, and 822 from client devices. That is, client devices may communicate with the systems 802, 812, and 822 through a public or private network, such as the Internet, to reach the secure access devices 808, 818, and 828, respectively. In some embodiments, the systems 802, 812, and 822 may provide client devices with access to data stored in the external storage 842 or 844. In some embodiments, the systems 802, 812, and 822 may provide client devices with information computed based, at least in part, on data stored in the external storage 842 or 844 by an application executing on the systems 802, 812, and 822.

The system 800 shown in FIG. 8 includes two active systems and one standby system, referred to as a 2+1 configuration. However, a system may include additional active systems or standby systems, generically referred to as an N+1 or N+M configuration. For example, the system 800 may include four active systems and one standby system. In another example, the system 800 may include four active systems and two standby systems.

When multiple active systems or standby systems are present, methods described above for operating a system or switching systems from standby to active or active to standby may be adjusted to account for the additional active or standby systems. For example, a method of replacing an active system with a standby system may include reconfiguring the standby system to match a configuration of the active system. Thus, the standby system may take over one of many different active systems. In such an embodiment, a method may include determining, at a standby processing system, to switch from an active processing system to the standby processing system; configuring the standby processing system to replace the active processing system; communicating, by the standby processing system to a switch, an instruction to switch from a first zone configuration to a second zone configuration; and acquiring, by the standby processing system, external storage coupled to the switch after the switch switches to the second zone configuration.

FIG. 9 illustrates a computer system 900 adapted according to certain embodiments of the processing systems 102 and/or 112 of FIG. 1. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the operations as described herein. The CPU 902 may execute the various logical instructions according to the present embodiments.

The computer system 900 also may include random access memory (RAM) 908, which may be synchronous RAM (SRAM), dynamic RAM (DRAM), synchronous dynamic RAM (SDRAM), or the like. The computer system 900 may utilize RAM 908 to store the various data structures used by a software application. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data, and both the RAM 908 and the ROM 906 may be randomly accessed.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a solid state storage device, a flash drive, a compact disc (CD) drive, a floppy disk drive, and a tape drive, to the computer system 900. According to one embodiment, the data storage 912 may be a separate server coupled to the computer system 900 through a network connection to the I/O adapter 910 from a switch. The communications adapter 914 may be adapted to couple the computer system 900 to the network, such as through a secure access device, which may be one or more of a LAN, WAN, and/or the Internet. The user interface adapter 916 couples user input devices, such as a keyboard 920, a pointing device 918, and/or a touch screen (not shown) to the computer system 900. The display adapter 922 may be driven by the CPU 902 to control the display on the display device 924. Any of the devices 902-922 may be physical and/or logical.

The applications of the present disclosure are not limited to the architecture of computer system 900. Rather the computer system 900 is provided as an example of one type of computing device that may be adapted to perform the functions of the processing systems 102 and/or 112. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 900 may be virtualized for access by multiple users and/or applications. In one embodiment, a computer system 900 may be a fabric including multiple server platforms, in which each server platform has a separate hypervisor. Alternatively, a single hypervisor may span multiple server platforms.

If implemented in firmware and/or software, the functions described above, such as with reference to FIGS. 3-6, may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus, comprising:
a first processing system comprising a first local storage;
a second processing system comprising a second local storage;
a third processing system comprising a third local storage;
an external storage;
a switch coupled to the first processing system, to the second processing system, to the third processing system, and to the external storage, in which the switch is configured to:
when the switch is in a first zone configuration, provide access to the external storage to the first processing system;
when the switch is in a second zone configuration, provide access to the external storage to the second processing system; and
when the switch is in a third zone configuration, provide access to the external storage to the third processing system.

2. The apparatus of claim 1, wherein the switch is coupled to the first processing system by fibre channel, and wherein the switch is coupled to the second processing system by fibre channel, and wherein the switch is coupled to the third processing system by fibre channel.

3. The apparatus of claim 1, wherein the switch is configured to switch from the first zone configuration to at least one of the second zone configuration and the third zone configuration based, at least in part, on a received command.

4. The apparatus of claim 1, wherein the first processing system is an active system and the second processing system is a standby system, wherein the switch provides access to the external storage to only one of the first processing system and the second processing system at a time.

5. The apparatus of claim 1, wherein the first processing system comprises:
a first processing module; and
a first services module coupled to the first processing module;
wherein the second processing system comprises:
a second processing module; and
a second services module coupled to the second processing module; and
wherein the third processing system comprises:
a third processing module; and
a third services module coupled to the third processing module.

6. The apparatus of claim 5, wherein the first processing module is an active system, wherein the second processing module is a standby system, wherein the first processing module is configured to provide access to an application executing on the first processing module, and wherein the second processing module is configured to provide access to an application executing on the second processing module when the first processing module is disabled.

7. The apparatus of claim 6, wherein the active system executes from the external storage, and wherein the standby system executes from the second local storage.

8. The apparatus of claim 1, wherein the second processing system is configured to, when the first processing module is disabled, change a halt-load unit of the second processing system to the external storage.

9. The apparatus of claim 8, wherein the first processing system is configured to, after the second processing system changes to the external storage, change a halt-load unit of the first processing system to the first local storage.

10. The apparatus of claim 1, further comprising a second switch configured to provide redundant access to the external disk.

11. The apparatus of claim 10, further comprising a second external storage coupled to the first switch and the second switch, wherein the second external storage is a mirror of the external storage.

12. The apparatus of claim 1, further comprising at least a second external storage coupled to the switch.

13. The apparatus of claim 1, further comprising a secure access device coupled to the first processing system and configured to provide access to the first processing system through a public network.

14. A method, comprising:
receiving, at a switch, a command to switch a zone configuration from a first zone configuration to at least one of a second zone configuration and a third zone configuration, wherein the first zone configuration provides access to an external storage to a first processing system, wherein the second zone configuration provides access to the external storage to a second processing system, and wherein the third zone configuration provides access to the external storage to a third processing system;
disabling, by the switch, access to the external storage by the first processing system; and
enabling, by the switch, access to the external storage by the second processing system.

15. The method of claim 13, wherein the first processing system is associated with a first host name and the second processing system is associated with a second host name.

16. The method of claim 14, further comprising, after enabling access to the external storage by the second processing system:
associating the first host name with the second processing system; and
associated the second host name with the first processing system.

17. A method, comprising:
determining, at a standby processing system, to switch from an active processing system to the standby processing system;
configuring the standby processing system to replace the active processing system;
communicating, by the standby processing system to a switch, an instruction to switch from a first zone configuration to a second zone configuration; and
acquiring, by the standby processing system, external storage coupled to the switch after the switch switches to the second zone configuration.

18. The method of claim 17, further comprising changing, by the standby processing system, a halt-load unit of the standby processing system to the external storage.

19. The method of claim 18, further comprising halt loading, by the standby processing system, off the external storage.

20. The method of claim 19, further comprising responding, by the standby processing system, to requests received at the standby processing system based, at least in part, on data located on the external storage.
